(19) United States
(12) Patent Application Publication
(10) Pub. No.: US 2016/0097459 A1
(43) Pub. Date: Apr. 7, 2016

(54) Nitrided Engine Valve with HVOF Coating

(71) Applicant: Caterpillar Inc., Peoria, IL (US)

(72) Inventors: Mark Veliz, Metamora, IL (US); Daniel Sordelet, Peoria, IL (US)

(73) Assignee: Caterpillar Inc., Peoria, IL (US)

(21) Appl. No.: 14/507,765

(22) Filed: Oct. 6, 2014

(51) Int. Cl. F16K 1/34; F02M 35/10; B05D 1/02; F16K 25/00

(52) U.S. Cl. CPC F16K 1/34; F16K 25/005; F02M 35/10255; B05D 1/02

(57) ABSTRACT

A valve for use in an internal combustion engine is disclosed. The valve includes a stem connected to a fillet disposed between the stem and a seat face. A thermal spray technique, such as a high velocity oxy fuel coating spray (HVOF) is applied to the seat face. A nitriding treatment that includes a nitrogen source, which may or may not contain carbon, and heat may be applied after the HVOF spray. The heat allows the nitrogen and/or carbon to penetrate the HVOF layer and the seat face to form a compound zone. The compound zone enhances the wear resistance of the surface during engine operation.

### TECHNICAL FIELD

The disclosure relates to coating a component with a wear-resistant coating, and more specifically, coating a valve of an engine with a wear-resistant thermal spray and a nitride treatment.

### BACKGROUND

Intake valves of engines are positioned in an intake port disposed between the air intake and a combustion chamber. During an air intake stroke, a cam or rocker arm pushes the intake valve open and allows a fuel mixture to enter the combustion chamber. Further, exhaust valves are positioned in an exhaust port disposed between the combustion chamber and an exhaust flow passage. During an exhaust stroke, the cam or rocker arm pushes the exhaust valve open and combustion gases are expelled from the chamber.

The seal that the valve makes with the port is important to engine performance and efficiency. If the seal leaks, the pressure in the combustion chamber decreases and the engine generates considerably less power. Engine manufacturers over the last few decades have dedicated substantial efforts in designing valves that can form a tight seal between the seat insert of the port and the seating face.

Both the seat insert and the seat face are important for the reliability of the valve. For example, it is well-known that corrosion or wear of either the seat insert or seat face can cause the valve to leak when the valve is closed, which results in “guttering.” To prevent guttering, the seat insert and the seat face on the valve fillet have been made with more wear resistant and more corrosion resistant materials. In some cases the same materials that have the increased wear resistance also have better corrosion resistance.

European Published Patent Application, EP 1, 548, 153 discloses a process for producing a multilayer coating with high abrasion resistance. The process includes depositing a first cermet coating on a surface of the material to be coated using the thermal spray technique; applying a surface finishing treatment, and depositing on the first cermet coating a nitride or carbon coating using a vapor phase deposition technique. However, this process may not allow all the applied coatings to properly diffusion bond to the relevant surfaces and thereby causing delamination. Delamination of the material that was coated will decrease the resistance to abrasion.

When wear occurs on the seat face or the seat insert of a reciprocating engine's valve, the geometry and the gap between the stem and the rocker are no longer optimized, and therefore adjustments need to be made, which are referred to as lash adjustments. Performing lash adjustments manually requires a vehicle to be taken out of service, which are an expense and a nuisance to the operator. A further problem with performing lash adjustments is that it requires removal of the valve covers, which opens the engine up to risk of contamination. Some vehicles are equipped with hydraulic lash adjusters (HLA), sometimes referred to as hydraulic lifters or hydraulic tappets that automatically adjust the gap between the stem tip and the rocker to maintain proper sealing and seating velocities. Heavy-duty diesel engines do not typically have HLA for several reasons including high valve train loads. Therefore, lash adjustments for most heavy duty diesel engines must be made manually, thereby requiring the engines to be taken out of service.

Thus, there is a need for improved process that provides sufficient wear resistance to valves in order to reduce or eliminate lash adjustments.

### SUMMARY

In one aspect, a valve for use in an internal combustion engine is disclosed. The valve may include a stem connected to a fillet, a seat face that connects to the stem by the fillet, and a wear resistant coating applied to the seat face, wherein the wear resistant coating includes a high velocity oxy fuel coating spray (HVOF) layer and a subsequent nitriding treatment that includes an application of heat, wherein the heat allows nitrogen to diffuse and bond with the HVOF layer and diffuse and bond with the seat face to form a compound zone on the HVOF layer.

In another aspect, an internal combustion engine is disclosed. The internal combustion engine may include an engine block including at least one combustion chamber, at least one air intake leading into the least one combustion chamber and defining a port configured to receive a valve, wherein the valve includes a stem connected to a fillet, a seat face that connects to the stem by the fillet, and a wear resistant coating applied to the seat face, wherein the wear resistant coating includes a high velocity oxy fuel coating spray (HVOF) layer and a nitriding treatment that includes an application of heat, wherein the heat allows nitrogen to diffuse and bond with the HVOF layer and diffuse and bond with the seat face to form a compound zone on the HVOF layer.

In yet another aspect, a method of improving an engine valve that includes applying a high velocity oxy fuel coating spray (HVOF) layer to a seat face of the engine valve, applying a nitriding treatment that includes an application of heat, heating nitrogen to cause the nitrogen to diffuse and bond with the HVOF layer and diffuse and bond with the seat face to form a compound zone on the HVOF layer, and creating a wear resistant coating on the seat face of the engine valve comprised of the HVOF layer and the nitriding treatment.

### BRIEF DESCRIPTION OF THE DRAWINGS

FIG. 1 illustrates a valve that may serve as an intake valve or an exhaust valve according to an aspect of the disclosure.

FIG. 2 illustrates the valve of FIG. 1 positioned within an engine of the vehicle according to an aspect of the disclosure.

FIG. 3 is an enlarged partial view of the contact between the seat insert that is accommodated in the port shown in FIG. 2 and the seat face shown in FIGS. 1-2.

FIGS. 4A and 4B illustrate a thermal spray technique and the effect of diffusion bonding.

FIG. 5 illustrates the substrate having the HVOF coating of FIG. 4 placed in an oven having a nitrogen source. In this illustration, the nitrogen source is ammonia.

FIGS. 6A and 6B illustrate the HVOF coating before and after the nitriding treatment.

FIG. 7 illustrates the nitriding process steps according to an aspect of the disclosure.

### DETAILED DESCRIPTION

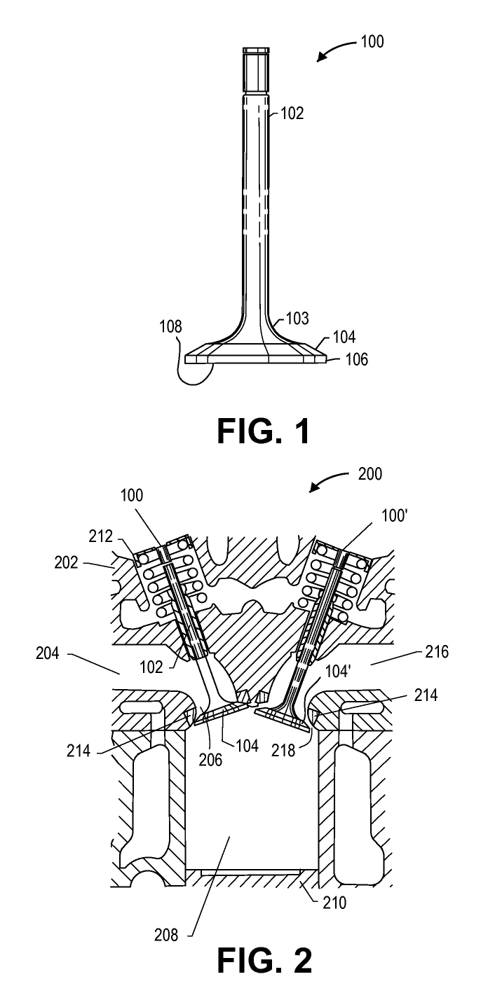

FIG. 1 illustrates a valve 100 that may serve as an intake valve or an exhaust valve according to an aspect of the disclosure. The valve 100 may include a stem 102 that may be connected to a fillet 103, which may connect the stem 102 to a seat face 104. The seat face 104 may be disposed between the fillet 103 and a margin 106, which may be disposed between the seat face 104 for and a combustion face 108. The valve 100 may be made of any material including alloy steels martensitic stainless steel alloys, austenitic stainless steel alloys such as 21-2N and 21-4N, nickel based super alloys such as Pyromet 31V, Nimonic 80A, or Inconel 751 alloy or any other material.

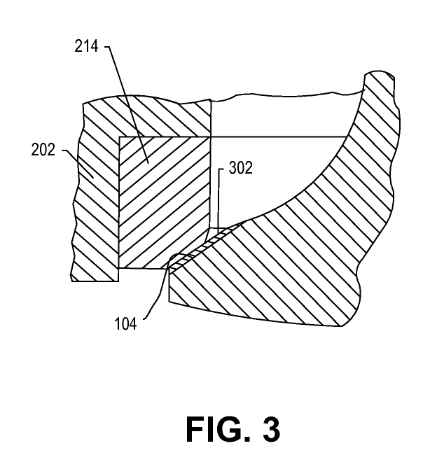

FIG. 2 illustrates the valve 100 of FIG. 1 positioned within an engine 200 of the vehicle according to an aspect of the disclosure. The valve 100 may be an intake valve that can be installed in a cylinder head 202 that may define an air intake 204 that terminates at an intake port 206. The intake port 206 may lead to a combustion chamber 208, which may slidably accommodate a piston 210 (only partially shown in FIG. 2). The valve 100 may be biased into the closed position shown in FIG. 2 by a spring or other biasing element 212. The stem 102 may extend upward through said biasing element 212 to be engaged by an actuator in the form of a rocker arm or cam (not shown in FIG. 2). As shown in FIG. 2, the seat face 104 may engage a valve seat insert 214 in the closed position in order to seal the combustion chamber 208. The valve seat insert 214 is typically made part of the engine for wear resistance of that part of the engine. As noted above, it is important to reduce the wear incurred by the seat face 104 interacting with the seat insert 214 to extend the time between lash resets. An enlarged view of the contact between the seat insert 214 having a coating 302 disposed on the seat face 104 is shown in FIG. 3. Also shown in FIG. 2 is another valve 100′ or exhaust valve installed in the cylinder head 202 that also defines an exhaust passage 216 and an exhaust port 218. Another valve seat insert 214 is provided for seat face 104′ so that in the closed position, the seat face 104′ seals the combustion chamber 208. The seat face 104′ may be coated in a manner similar to the seat face 104 of the valve 100. The exhaust valve 100′operates at about 100 to 300° C. higher than the intake valve 100 due to the heated combusted gas being exhausted from the combustion chamber.

FIG. 3 is an enlarged partial view of the contact between the seat insert 214 that is accommodated in the port 206 shown in FIG. 2 and the seat face 104 shown in FIGS. 1-2. The seat insert can be positioned in the cylinder head 202. The seat face 104 includes the coating 302 resulting from the nitride treatment described herein that will increase the wear resistance as seat face 104 interacts with seat insert 214.

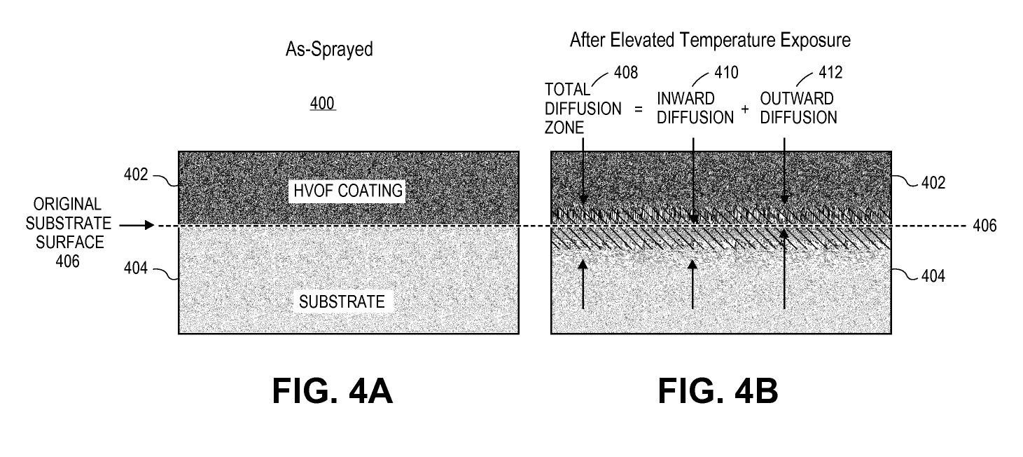

FIGS. 4A and 4B illustrate a thermal spray technique 400 and the effect of diffusion bonding. The thermal spray technique can be any technique such as controlled atmosphere plasma spray, vacuum plasma spray, high velocity air fuel (HVAF), or high velocity oxy fuel (HVOF). As shown in FIG. 4A, in one aspect of the disclosure, the HVOF process can be used to spray various coating materials, including cermet materials containing hard ceramic constituents within a softer metallic binder phase. The ceramics can be carbides, nitrides, oxides and the like. The HVOF coating 402 can be sprayed over any substrate 404, such as the seat face 104 and the sprayed thickness can range from 100 to 500 microns. The original substrate surface 406 is also illustrated. The HVOF technique is essentially using a heated supersonic jet to deposit a metallic powder, which melts and coats the substrate 404.

FIG. 4B illustrates the effects of HVOF coating 402 after the application of elevated temperature. The elevated temperature allows a total diffusion zone 408 which may be formed by both an inward diffusion 410 from the HVOF coating 402 into the substrate 404 and an outward diffusion 412 from the substrate 404 into the HVOF coating 402. The inward diffusion 410 of the HVOF coating 402 may be from about 1 to 50 microns thick or more while the outward diffusion 412 from the substrate 404 may also be about 1 to 50 microns thick or more.

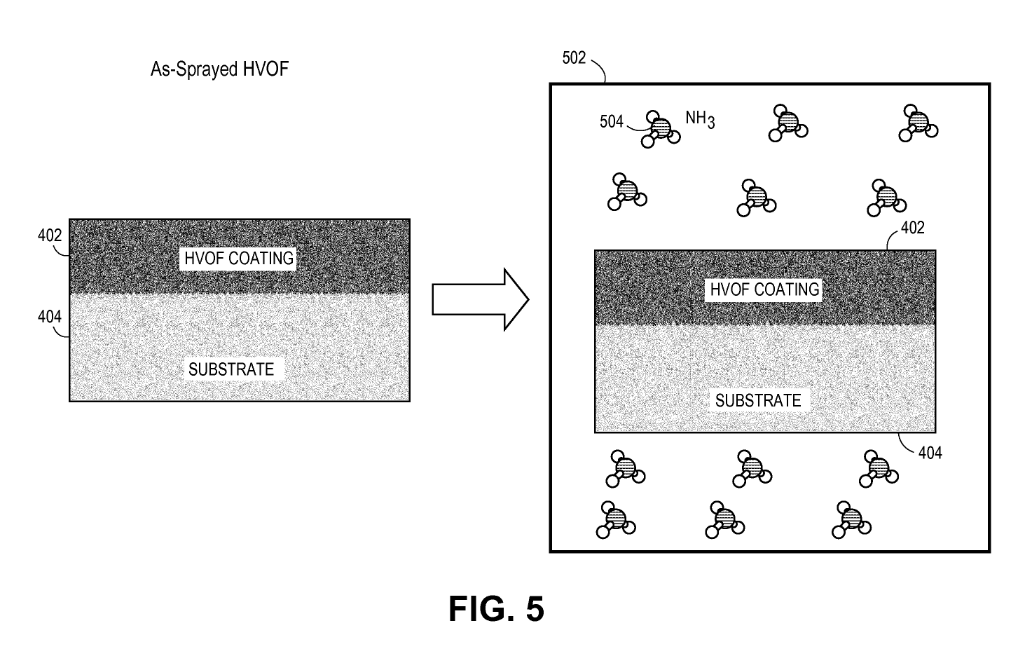

FIG. 5 illustrates the substrate 404 having the HVOF coating 402 of FIG. 4 placed in an oven 502 having a nitrogen source. In this example shown, the nitrogen source is ammonia (NH₃) 504. The oven can be any oven including a furnace oven that can contain the substrate 404 or the valve 100 and the nitrogen source. The oven temperature may be set between 300° C. to 800° C. or between 450° C. to 650° C. or at any other temperature desired by the operator. The oven temperature should be high enough to perform the nitriding treatment as described herein. The nitriding treatment may be done at oven temperatures set between 300° C. to 800° C. for about 1-48 hours or about 24 hours depending on the alloy of the valve 100 or the coating material used the thermal spray or the particular nitriding process used. In gas nitriding, when ammonia comes into contact with the valve 100 it disassociates into nitrogen and hydrogen. The nitrogen then diffuses onto the surface of the valve 100 creating a nitride layer. The nitriding treatment can be performed on any or all parts of the valve 100 including the stem 102, the fillet 103, the seat face 104, the margin 106 and the combustion face 108. It should be noted that any components such as components used in vehicles that need wear resistant characteristics can be subjected to this nitriding treatment process.

The process for nitriding described herein is for gas nitriding. However, the process can also be ion nitriding, which involves the use of plasma. Ion nitriding involves intense electric fields that are used to generate ionized molecules of the gas around the surface to be nitrided. In another aspect of the disclosure, a salt bath nitriding process can be used. In yet another aspect of the disclosure, a salt bath ferritic nitrocarburizing process can be used. It should be noted that in the salt bath ferritic nitrocarburizing process, the predominant species diffusing into and reacting with the metal of the valve 100 and/or HVOF coating is nitrogen, though some carbon is available to diffuse into and react with the metal. Because nitrogen is the predominant species diffusing into the metal, the processes discussed herein relate to nitrogen but can certain processes are also applicable to carbon.

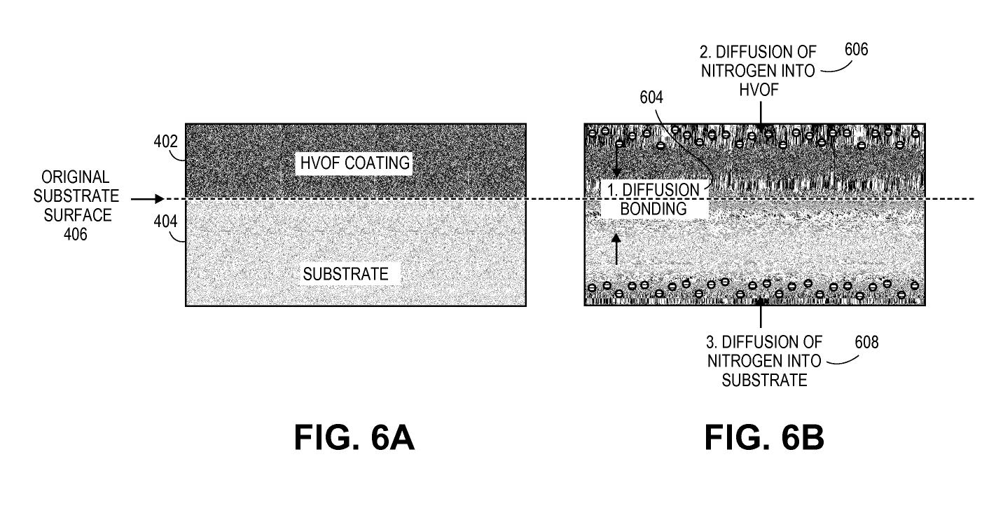

FIGS. 6A and 6B illustrate the HVOF coating before and after the nitriding treatment. FIG. 6A shows the HVOF coating 402 sprayed over the substrate 404, such as the seat face 104 before the nitriding treatment. FIG. 6B shows the nitrogen diffusing into the HVOF coating 402 and the substrate 404 thereby creating a more wear resistant coating. With the application of heat in the oven 502 containing the nitrogen source better diffusion bonding occurs between the HVOF coating and the valve base material (substrate). Diffusion bonding 604 occurs independent of the presence of the nitrogen source, and occurs by being thermally activated by the application of heat during the nitriding treatment process. In this aspect of the disclosure, inward diffusion 606 of nitrogen into the HVOF coating 402 may be about 2-60 microns or 5-50 microns in the event a Stellite 1 (cobalt-chromium alloy) HVOF coating was used. However, the inward diffusion 606 may be more of less depending on the type of materials used in the HVOF coating 402. The addition of nitrogen to the surface can form a ceramic nitride layer on or near the surface of the HVOF coating 402 known as a compound zone. The compound zone may be made of mainly CrN due to the high chromium content in the Stellite 1. The thickness of the compound zone may be about 0.5-50 microns or more or less depending on the nitrogen penetration and amount of heat and the amount of time of the application of heat.

The inward diffusion 608 of nitrogen into the substrate 404 may be about 10-170 microns or about 30-150 microns depending on the valve's 100 alloy. A thin additive layer may be formed on or near the original substrate surface 406 also known as the compound zone. The compound zone is expected to be primarily CrN due to the high chromium content in most valve alloys. The thickness of the compound zone may be about 0.5-50 microns or more or less depending on the nitrogen penetration and amount of heat and the amount of time of the application of heat.

Through the nitriding treatment process, compound layers may be formed on both the HVOF coating 402 and the original substrate surface 406 thereby increasing the wear resistance of the coating 302 on valve seat face 104. This also helps to improve adhesion of the HVOF coating 402 to the underlying vavle alloy. The nitriding process imparts a compressive residual stress that helps in fatigue resistance. It should be noted that in another aspect of the disclosure, a nitriding treatment may also be used to impart improved fatigue resistance on the valve 100, including the fillet and the stem.

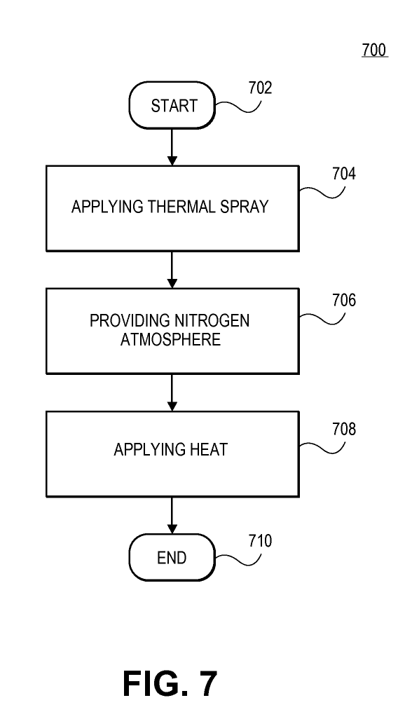

FIG. 7 illustrates the nitriding process steps 700 according to an aspect of the disclosure. The nitriding process may start at step 702. At step 704, a thermal spraying technique, such as HVOF coating is applied to the seat face 104, the stem 102, or any part of the valve 100. The HVOF coating may include any material including cermet materials containing hard ceramic constituents within a softer metallic binder phase. The ceramics can be carbides, nitrides, oxides and the like. In an alternative aspect of the disclosure, a surface treatment to the HVOF coating may be done after the application of HVOF coating to the seat face 104. The surface treatment may include grinding. At step 706, an ammonia 504 and/or carbon rich atmosphere environment may be provided. The environment may be in the oven 502. At step 708, heat is applied in the oven 502 so that the nitrogen and/or carbon inwardly diffuse into the HVOF coating 402 and/or the seat face 104 to form various compound zones. The time of heating may range from 1-48 hours depending on the temperature, the type of HVOF coating 402, the type of nitriding processes, the alloy of the valve 100 and other operating conditions. At step 710, the process ends. The process described herein can be used on all parts of the valve and not simply the seat face 104 and can be performed in any order.

### INDUSTRIAL APPLICABILITY

Improved valves for internal combustion engines are provided. Intake valves and exhaust valves wear out during their use in an engine, thereby causing down time of the engine in order to replace the valves or realign the valves. A processing of nitriding a thermal spray layer, such as a HVOF coating on the valve is provided. The valve may be thermally sprayed with the HVOF coating and then put into an oven having a nitrogen, and/or carbon rich environment. Heat is applied for several hours as part of the nitriding treatment process, which allows better adhesion of the HVOF coating to the valve and thereby increasing the wear resistant of the HVOF coating.

We claim:

1. A valve for use in an internal combustion engine, the valve comprising:
a stem connected to a fillet;
a seat face that connects to the stem by the fillet; and
a wear resistant coating applied to the seat face, wherein the wear resistant coating includes a high velocity oxy fuel coating spray (HVOF) layer and a nitriding treatment that includes an application of heat, wherein the heat allows nitrogen to diffuse and bond with the HVOF layer and diffuse and bond with the seat face to form a compound zone on the HVOF layer.

2. The valve of claim 1, wherein the heat is applied at about 300° C. to about 800° C. for about 24-48 hours.

3. The valve of claim 1, wherein the heat is applied at about 500° C. to about 650° C. for about 1-48 hours.

4. The valve of claim 1, wherein the nitrogen is provided by a nitriding process.

5. The valve of claim 4, wherein the nitriding process includes gas nitriding, salt bath nitriding, or salt bath ferritic nitrocarburizing.

6. The valve of claim 4, wherein a carbon is also in the nitriding process.

7. The valve of claim 1, wherein the compound zone also forms on the seat face.

8. The valve of claim 1, wherein the heat is applied by the engine.

9. The valve of claim 1, wherein the compound zone is about 0.5 to about 50 microns.

10. The valve of claim 1, wherein a stem, a fillet or a margin is also coated with the wear resistant coating.

11. The valve of claim 1, wherein the valve is an intake valve or an exhaust valve.

12. An internal combustion engine, comprising:
a cylinder engine block including at least one combustion chamber;
at least one air intake leading into the least one combustion chamber and defining a port configured to receive a valve, wherein the valve comprises:
a stem connected to a fillet;
a seat face that connects to the stem by the fillet; and
a wear resistant coating applied to the seat face, wherein the wear resistant coating includes a high velocity oxy fuel coating spray (HVOF) layer and a nitriding treatment that includes an application of heat, wherein the heat allows nitrogen to diffuse and bond with the HVOF layer and diffuse and bond with the seat face to form a compound zone on the HVOF layer.

13. The engine of claim 12, wherein the valve is an intake valve or an exhaust valve.

14. The engine of claim 12, wherein the heat is applied at about 500° C. to about 650° C. for about 1-48 hours.

15. The engine of claim 12, wherein the nitrogen is provided by a nitriding process.

16. The engine of claim 15, wherein the nitriding process includes gas nitriding, salt bath nitriding, or salt bath ferritic nitrocarburizing.

17. The engine of claim 15, wherein a carbon is also in the nitriding process.

18. The engine of claim 12, wherein the compound zone also forms on the seat face.

19. The engine of claim 12, wherein the heat is applied by the engine.

20. A method of improving an engine valve, comprising the steps of:
applying a high velocity oxy fuel coating spray (HVOF) layer to a seat face of the engine valve;
applying a nitriding treatment that includes an application of heat;
heating nitrogen to cause the nitrogen to diffuse and bond with the HVOF layer and diffuse and bond with the seat face to form a compound zone on the HVOF layer; and
creating a wear resistant coating on the seat face of the engine valve with the HVOF layer and the nitriding treatment.
